(19) United States
(12) Patent Application Publication
(10) Pub. No.: US 2023/0254786 A1
(43) Pub. Date: Aug. 10, 2023

(54) METHOD AND APPARATUS FOR C-V2X SYNCHRONIZATION

(71) Applicant: QUALCOMM Incorporated, San Diego, CA (US)

(72) Inventors: Soumya DAS, San Diego, CA (US); Mohammad NEKOUI, San Diego, CA (US)

(21) Appl. No.: 17/650,504

(22) Filed: Feb. 9, 2022

(51) Int. Cl. H04W 56/00; H04W 4/40

(52) U.S. Cl. CPC H04W 56/001; H04W 4/40

(57) ABSTRACT

Method and apparatus for C-V2X synchronization. The apparatus detects an object in an environment that obstructs synchronization with a network. The apparatus transmits, via at least one transceiver, to at least one second wireless device, a message indicating the object that obstructs the synchronization with the network. The apparatus may receive, from a third wireless device, an indication that identifies the object in the environment that obstruct the synchronization with the network. To detect the object in the environment, the apparatus may receive, from a wireless device, an indication that identifies the object in the environment that obstructs the synchronization with the network.

### TECHNICAL FIELD

The present disclosure relates generally to communication systems, and more particularly, to techniques and configurations for cellular vehicle to anything (C-V2X) synchronization.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. Aspects of wireless communication may comprise direct communication between devices, such as in V2X, V2V, and/or D2D communication. There exists a need for further improvements in V2X, V2V, and/or D2D technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a first wireless device. The device may be a processor and/or a modem at a first wireless device or the first wireless device itself. The apparatus detects an object in an environment that obstructs synchronization with a network. The apparatus transmits, to at least one second wireless device, a message indicating the object that obstructs the synchronization with the network.

In an aspect of the disclosure, a method, a computer-readable medium, and an apparatus are provided. The apparatus may be a device at a second wireless device. The device may be a processor and/or a modem at a second wireless device or the second wireless device itself. The apparatus receives, from a first wireless device, a message indicating an object that obstructs synchronization with a network. The apparatus performs a synchronization mitigation action in response to receiving the message indicating the object that obstructs synchronization with the network.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a base station and user equipment (UE) in an access network.

FIG. 4 is a diagram illustrating an example of devices involved in wireless communication based, e.g., on sidelink communication.

FIGS. 5A-5D are diagrams illustrating examples of sensor-sharing for cooperative and automated driving systems.

FIG. 6 is a diagram illustrating an example of sensor-sharing for cooperative and automated driving systems.

FIG. 7 is a diagram illustrating an example of sensor-sharing for cooperative and automated driving systems.

FIG. 8 is a diagram illustrating an example of detection of a threat entity.

FIG. 9 is a diagram illustrating an example of sensor data sharing message structure.

FIG. 10 is a diagram illustrating an example of sensor data sharing message structure.

FIG. 11 is a diagram illustrating an example of information elements for detected objects in sensor data sharing message.

FIG. 12 is a call flow diagram of signaling between a first wireless device, a second wireless device, and a third wireless device.

FIG. 13 is a flowchart of a method of wireless communication.

FIG. 14 is a flowchart of a method of wireless communication.

FIG. 15 is a diagram illustrating an example of a hardware implementation for an example apparatus.

FIG. 16 is a flowchart of a method of wireless communication.

FIG. 17 is a flowchart of a method of wireless communication.

FIG. 18 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

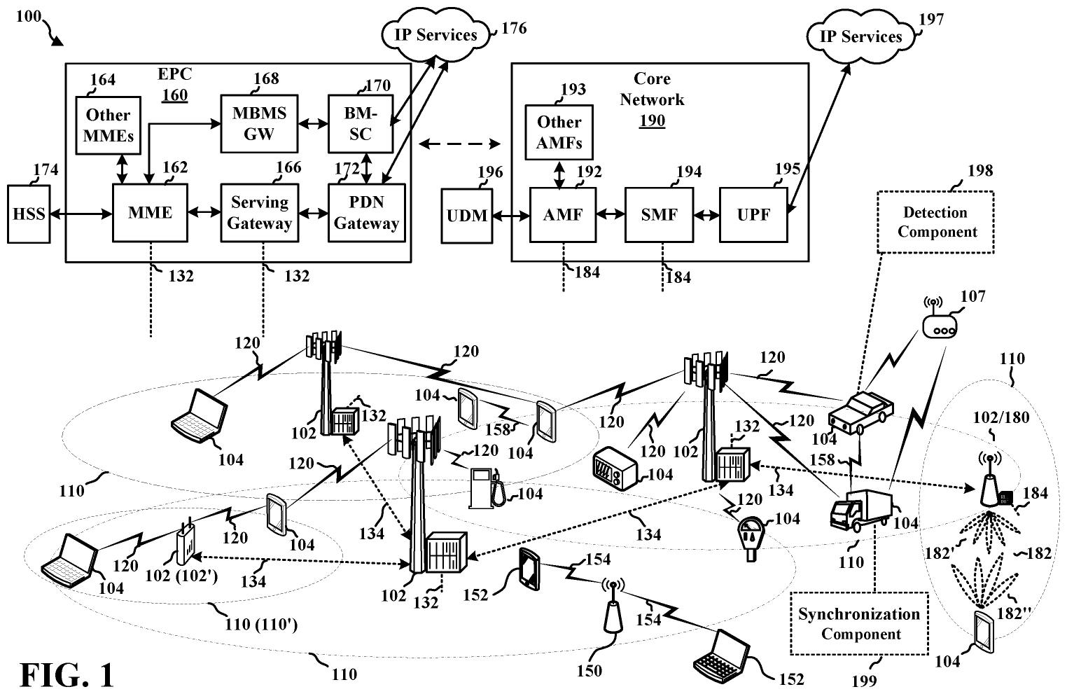

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions . The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly be applied by UE 104 or RSU 107 to communicate with another UE 104 or RSU 107, such as based on sidelink communication such as V2X or D2D communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

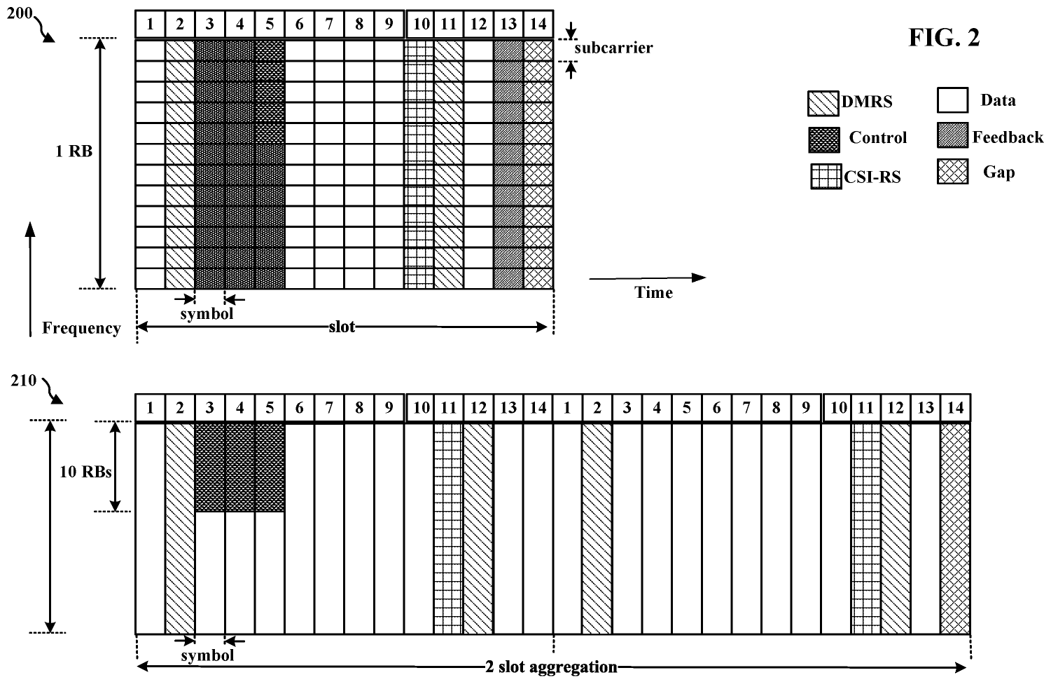

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), cellular-vehicle-to everything (C-V2X), enhanced V2X (e-V2X), and/or a combination thereof and/or with other devices, which can be collectively referred to as vehicle-to-anything (V2X) communications. Referring again to FIG. 1, in certain aspects, a UE 104, e.g., a transmitting Vehicle User Equipment (VUE) or other UE, may be configured to transmit messages directly to another UE 104. The communication may be based on V2X or other D2D communication, such as Proximity Services (ProSe), etc. Communication based on V2X and/or D2D communication may also be transmitted and received by other transmitting and receiving devices, such as Road Side Unit (RSU) 107, etc. Aspects of the communication may be based on PC5 or sidelink communication e.g., as described in connection with the example in FIG. 2. Although the following description may provide examples for V2X/D2D communication in connection with 5G NR, the concepts described herein may be applicable to other similar areas, such as LTE, LTE-A, CDMA, GSM, and other wireless technologies.

Referring again to FIG. 1, in certain aspects, the UE 104 may be configured to detect or perceive GNSS challenged environments. For example, the UE 104 detects an object in an environment that obstructs synchronization with a network. The UE 104 transmits, to at least one second wireless device, a message indicating the object that obstructs the synchronization with the network.

Referring again to FIG. 1, in certain aspects, the UE 104 may be configured to commence synchronization mitigating actions in response to receiving an indication of a GNSS challenged environment. For example, the UE 104 receives, from a first wireless device, a message indicating an object that obstructs synchronization with a network. The UE 104 performs a synchronization mitigation action in response to receiving the message indicating the object that obstructs synchronization with the network.

FIG. 2 illustrates an example diagram 200 illustrating a sidelink subframe within a frame structure that may be used for sidelink communication, e.g., between UEs 104, between a UE and infrastructure, between a UE and an RSU, etc. The frame structure may be within an LTE frame structure. Although the following description may be focused on LTE, the concepts described herein may be applicable to other similar areas, such as 5G NR, LTE-A, CDMA, GSM, and other wireless technologies. This is merely one example, and other wireless communication technologies may have a different frame structure and/or different channels. A frame (10 ms) may be divided into 10 equally sized subframes (1 ms). Each subframe may include two slots. Each slot may include 7 SC-FDMA symbols. For slot configuration 0, each slot may include 14 symbols, and for slot configuration 1, each slot may include 7 symbols. Although the diagram 200 illustrates a single RB subframe, the sidelink communication may include multiple RBs.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include a reference signal, such as a demodulation RS (DMRS). At least one symbol may be used for feedback, as described herein. A symbol prior to and/or after the feedback may be used for turnaround between reception of data and transmission of the feedback. Another symbol, e.g., at the end of the subframe may be used as a guard symbol without transmission/reception. The guard enables a device to switch from operating as a transmitting device to prepare to operate as a receiving device, e.g., in the following subframe. Data or control may be transmitted in the remaining REs, as illustrated. For example, data may be carried in a PSSCH, and the control information may be carried in a PSCCH. The control information may comprise Sidelink Control Information (SCI). The position of any of the reference signals, control, and data may be different than the example illustrated in FIG. 2.

FIG. 2 merely illustrates one, non-limiting example of a frame structure that may be used. Aspects described herein may be applied to communication using other, different frame formats.

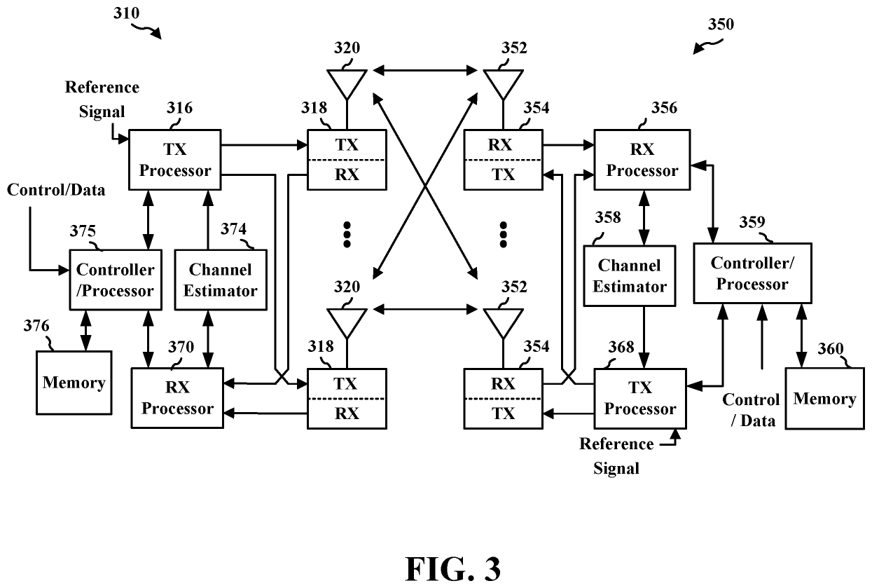

FIG. 3 is a block diagram of a first wireless communication device 310 in communication with a second wireless communication device 350, e.g., via V2V/V2X/other communication. The device 310 may comprise a transmitting device communicating with a receiving device, e.g., device 350. The communication may be based, e.g., on sidelink. The transmitting device 310 may comprise a UE, an RSU, etc. The receiving device may comprise a UE, an RSU, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, or the controller/processor 359 of device 350 or the TX 316, the RX processor 370, or the controller/processor 375 may be configured to perform aspects described in connection with 198 or 199 of FIG. 1.

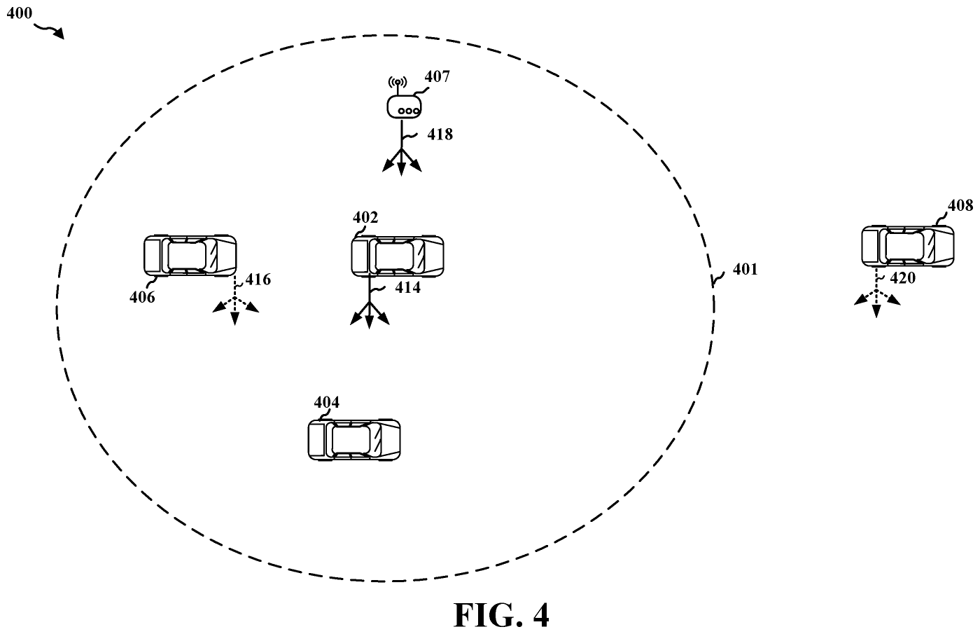

FIG. 4 illustrates an example 400 of wireless communication between devices based on sidelink communication, such as V2X or other D2D communication. The communication may be based on a slot structure comprising aspects described in connection with FIG. 2. For example, transmitting UE 402 may transmit a transmission 414, e.g., comprising a control channel and/or a corresponding data channel, that may be received by receiving UEs 404, 406, 408. At least one UE may comprise an autonomous vehicle or an unmanned aerial vehicle. A control channel may include information for decoding a data channel and may also be used by receiving device to avoid interference by refraining from transmitting on the occupied resources during a data transmission. The number of TTIs, as well as the RBs that will be occupied by the data transmission, may be indicated in a control message from the transmitting device. The UEs 402, 404, 406, 408 may each be capable of operating as a transmitting device in addition to operating as a receiving device. Thus, UEs 406, 408 are illustrated as transmitting transmissions 416, 420. The transmissions 414, 416, 420 may be broadcast or multicast to nearby devices. For example, UE 414 may transmit communication intended for receipt by other UEs within a range 401 of UE 414. Additionally/alternatively, RSU 407 may receive communication from and/or transmit communication to UEs 402, 404, 406, 408.

UE 402, 404, 406, 408 or RSU 407 may comprise an object component, similar to 198 described in connection with FIG. 1. UE 402, 404, 406, 408 or RSU 407 may also comprise a synchronization component, similar to 199 described in connection with FIG. 1.

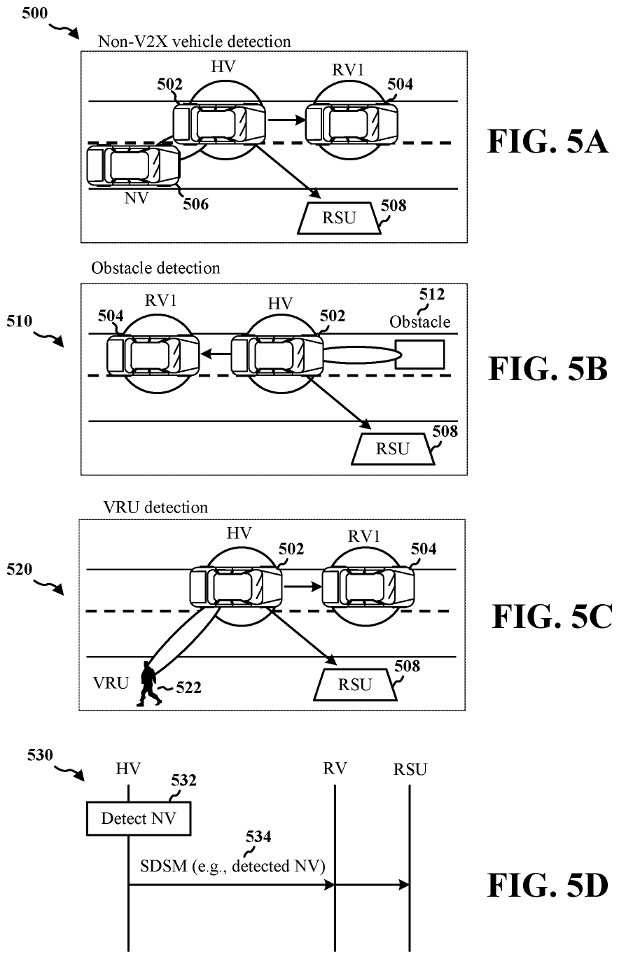

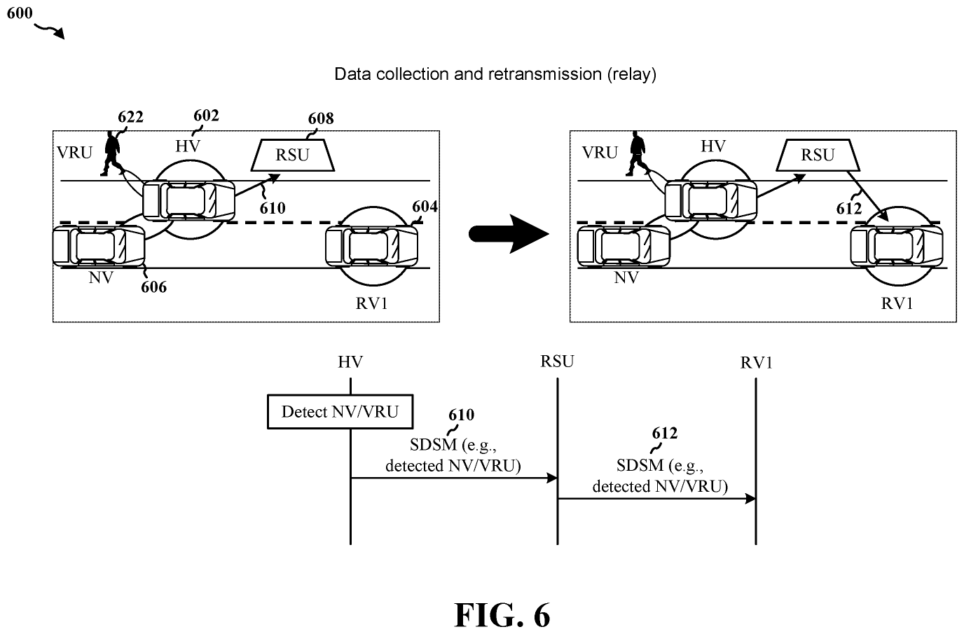

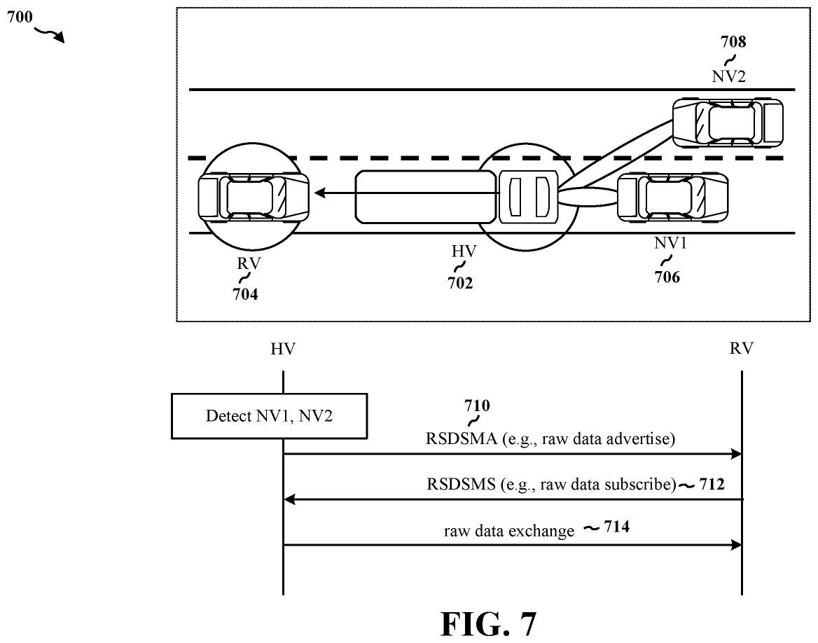

In wireless communications, such as V2X communications, V2X entities may perform sensor sharing with other V2X entities for cooperative or automated driving. For example, with reference to diagram 500 of FIG. 5A, the host vehicle (HV) 502 may detect a number of items or objects within its environment. For example, the HV 502 may detect the presence of the non-V2X entity (NV) 506. The HV 502 may inform other entities, such as a first remote vehicle (RV1) 504 or a road side unit (RSU) 508, about the presence of the NV 506, if the RV1 504 and/or the RSU 508, by themselves, are unable to detect the NV 506. The HV 502 informing the RV1 504 and/or the RSU 508 about the NV 506 is an example of sharing of sensor information. With reference to diagram 510 of FIG. 5B, the HV 502 may detect a physical obstacle 512, such as a pothole, debris, or an object that may be an obstruction in the path of the HV 502 and/or RV1 504 that has not yet been detected by RV1 504 and/or RSU 508. The HV 502 may inform the RV1 and/or the RSU 508 of the obstacle 512, such that the obstacle 512 may be avoided. With reference to diagram 520 of FIG. 5C, the HV 502 may detect the presence of a vulnerable road user (VRU) 522 and may share the detection of the VRU 522 with the RV1 504 and the RSU 508, for example, in instances where the RSU 508 and/or RV1 504 may or may not be able to detect the VRU 522. With reference to diagram 530 of FIG. 5D, the HV, upon detection of a nearby entity (e.g., NV, VRU, obstacle) may transmit a sensor data sharing message (SDSM) 532 to the RV and/or the RSU to share the detection of the entity. The SDSM 532 may be a broadcast message such that any receiving device within the vicinity of the HV may receive the message. In some aspects, the SDSM 532 may be a groupcast message such that a receiving device within a group of receiving devices may receive the message from the HV. In some aspects, the SDSM 532 may be a unicast message such that the HV is only sending the SDSM 532 to one specified receiving device. In some instances, the shared information may be relayed to other entities, such as RVs. For example, with reference to diagram 600 of FIG. 6, the HV 602 may detect the presence of the NV 606 and/or the VRU 622. The HV 602 may broadcast, groupcast, or unicast the SDSM 610 to the RSU 608 to report the detection of NV 606 and/or VRU 622. The RSU 608 may relay the SDSM 610 received from the HV 602 to remote vehicles such that the remote vehicles are aware of the presence of the NV 606 and/or VRU 622. For example, the RSU 608 may transmit an SDSM 612 to the RV1 604, where the SDSM 612 includes information related to the detection of NV 606 and/or VRU 622. In some instances, remote vehicles may be updated repeatedly. For example, with reference to diagram 700 of FIG. 7, the HV 702 may detect the NV1 706 and/or NV2 708 and may share the presence of NV1 706 and/or NV2 708 with the RV 704. The HV 702 may transmit an SDSM 710 that advertises the raw data collected by the HV 702. The RV 704 may transmit an SDSM 712 which may comprise a request to subscribe to the raw data advertised by the HV 702. In response, the HV may transmit a raw data exchange 714 to the RV 704. Information related to certain objects may be included in an SDSM. For example, the SDSM may include information related to non-V2X vehicles, obstacles, or VRUs. These are objects that may be physically detected and may pose a physical obstruction or barrier to the pathway of a V2X vehicle. However, some objects may pose a risk to the cooperative or automated driving decisions of V2X vehicles.

C-V2X may allow vehicles to communicate with each other without network coverage, and GNSS is often used as the primary synchronization source. For locations where there is no GNSS signal, other synchronization sources may be used to enable C-V2X communications. For example, a UE may be configured to become a source for synchronization. A UE directly or indirectly synchronized with GNSS or the network may transmit sidelink synchronization signals to provide a synchronization source to nearby UEs. The transmission of the sidelink synchronization signals may be triggered by preconfigured rules. A UE may transmit sidelink synchronization signals to become an independent synchronization source, as such in instances where the UE could not detect any GNSS signals or any sidelink synchronization signals from other UEs. If UEs are not transmitting sidelink synchronization signals all the time or in a periodic manner, this may delay the synchronization of UEs that lost GNSS synchronization and may affect C-V2X reliability.

Aspects presented herein provide techniques and configurations for sensor data sharing message (SDSM) aided sidelink synchronization signal block (S-SSB) for C-V2X synchronization. For example, a first wireless device may transmit a message to at least a second wireless device regarding an object that obstructs synchronization, such that at least the second wireless device may perform a synchronization mitigation action in response to receiving the message from the first wireless device. At least one advantage of the disclosure is that perceived detection of GNSS challenged environments may allow other wireless device to become a synchronization source or to latch onto an available synchronization source prior to encountering the GNSS challenged environments.

A V2X UE may derive its own synchronization using 4 basic timing sources, namely, GNSS, from its serving base station, another UE transmitting S-SSB (e.g., a SyncRef UE), or its own internal clock. A UE without a synchronization source may choose a synchronization source based on a priority. For example, the order of priority may comprise GNSS, a serving cell, another UE transmitting S-SSB, or its own internal clock. In some aspects, the order of priority may be any combination of the GNSS, the serving cell, another UE transmitting S-SSB, or the internal clock. A UE with a synchronization source may change its synchronization source based on priority and a sidelink reference signal received power (S-RSRP) of a received S-SSB. A UE may become a synchronization source (e.g., SyncRef UE) and start transmitting S-SSB in certain instances. For example, when GNSS is the source of the synchronization, the UE may transmit S-SSB if it is not within coverage of a base station. If the UE is within coverage of the base station, the UE may transmit S-SSB if the RSRP of the base station is below a threshold. If the UE is synchronized to a SyncRef UE, the UE may transmit S-SSB if the S-RSRP from the SyncRef UE is below a threshold. If a synchronization source is not available, the UE may transmit S-SSB using its internal clock.

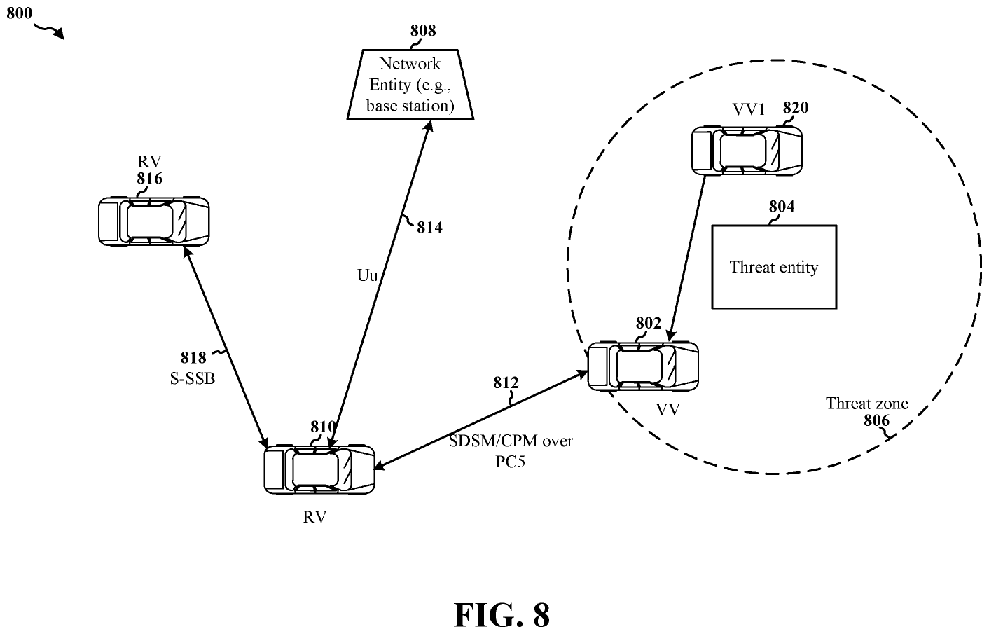

FIG. 8 is a diagram 800 illustrating an example of detection of a threat entity or object that may obstruct synchronization with a network. In some instances, a victim vehicle (VV) 802 may be a V2X entity and may encounter a threat entity 804. The VV 802 may encounter the threat entity 804 while being within the threat zone or environment 806 of the threat entity 804. The VV 802 may detect the presence of the threat entity 804, and may detect characteristics of the threat entity 804. In some instances, the threat entity 804 may be in the form of a DoS attack, a jammer, a misbehaving vehicle, an out of band (OOB) interferer, a wide area network (WAN) jammer, a global navigation satellite systems (GNSS) jammer. In some instances, the threat entity 804 may be related to the environment, landscape, or terrain (e.g., canyon or tunnel). The diagram 800 of FIG. 8 discloses one threat entity 804 that may pose a threat to VV 802. However, in some aspects, the threat to VV 802 may be posed by or may come from one or more threat entities. The one or more threat entities may be stationary or mobile. For example, a stationary threat entity may be located at a nearby building or outside a building near a street or intersection, while a mobile threat entity may comprise a vehicle.

Once the VV 802 detects the threat entity 804, the VV 802 may receive a notification that identifies the threat entity 804 such that normal C-V2X operation may be halted. In some instances, the notification may be from a wireless device (e.g., VV1 820) that may have already encountered the threat entity 804. In some instances, the notification may be from an onboard unit (OBU) of the VV 802 in response from one or more sensors of the VV 802 that detect and/or identify the threat entity 804. C-V2X operation may be halted upon detection of the threat entity 804 due to the threat entity 804 obstructing or interfering with the wireless resources or spectrum used in cooperative and automated driving decisions. For example, safety features of C-V2X operation may be obstructed that may pose a danger to other road users. As such, transmission of basic safety messages (BSMs) may be halted upon detection of the threat entity 804. In some instances, the threat entity 804 may obstruct synchronization with the network such that communication with the network or other wireless devices may be obstructed.

The threat entity 804 may impact GNSS and may be considered as a new class of detected objects, in a manner similar to detected NVs, VRUs, or physical obstacles in FIGS. 5A-7. As such, the detection of the threat entity 804 may be encoded as an SDSM or cooperative perception message (CPM). In some instances, the SDSM or CPM may indicate that GNSS is out of coverage in areas like tunnels or urban canyons. The SDSM or CPM may indicate available synchronization sources in such conditions including proximate RSUs or SyncRef UEs and the corresponding sidelink synchronization signals (SLSS) identifier (ID). The SLSS ID range may be indicated in the SDSM or CPM in instances where nearby RSUs pick IDs from a smaller range, which may help with enhancing the synchronization search. The dissemination of such information may allow the nearby RVs (e.g., 810) to make a decision to either become a synchronization source and transmit S-SSB 81X or to latch onto an existing synchronization source (e.g., RSU 808) before entering the challenging GNSS environment (e.g., threat zone 806).

The SDSM or CPM may be broadcasted by the VV 802 to reach remote vehicles (RVs) 810 that are outside the threat zone or environment 806 of the threat entity 804. In some aspects, the VV 802 may broadcast the SDSM or CPM over a PC5 link 812 to a RV 810. The RV 810 may be within the range of sidelink transmission of the VV 802 in order to receive the SDSM or CPM over the PC5 link 812. The RV 810 may determine to become a synchronization source or latch onto an existing synchronization source such as a network entity (e.g., RSU 808) prior to entering or encountering the challenging GNSS environment based on receiving the SDSM or CPM from VV 802. In some aspects, the VV 802 may receive an indication that identifies the object or threat entity 804 that obstructs the synchronization. In some instances, the VV 802 may receive the indication that identifies the object or threat entity 804 from the OBU of the VV 802. For example, the OBU of the VV 802 may combine a measured RSSI of the threat entity 804 with readings from one or more sensors (e.g., camera, radar, LIDAR) of the VV 802 to detect and/or identify the threat entity 804. In some instances, the VV 802 may receive the indication that identifies the object or threat entity 804 from VV1 820. For example, the VV1 820 may have already encountered/detected and/or identified the threat entity 804 and may transmit a signal to nearby wireless devices that announces the presence and identity of the threat entity 804. The VV1 820 may have already encounter or detected the threat entity 804 due to being closer to the threat entity 804 than that of other wireless devices (e.g., VV 802).

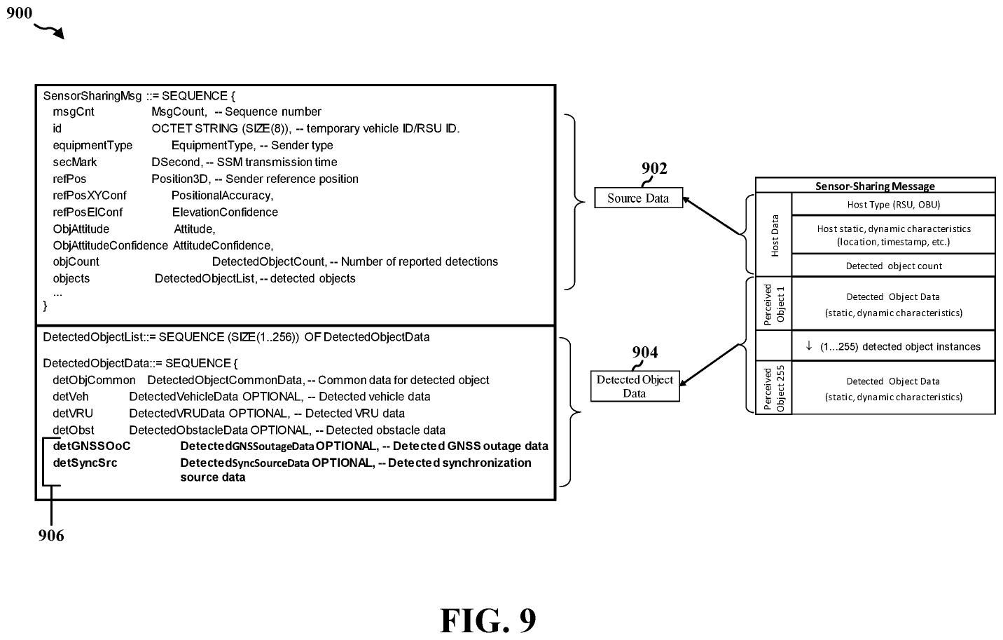

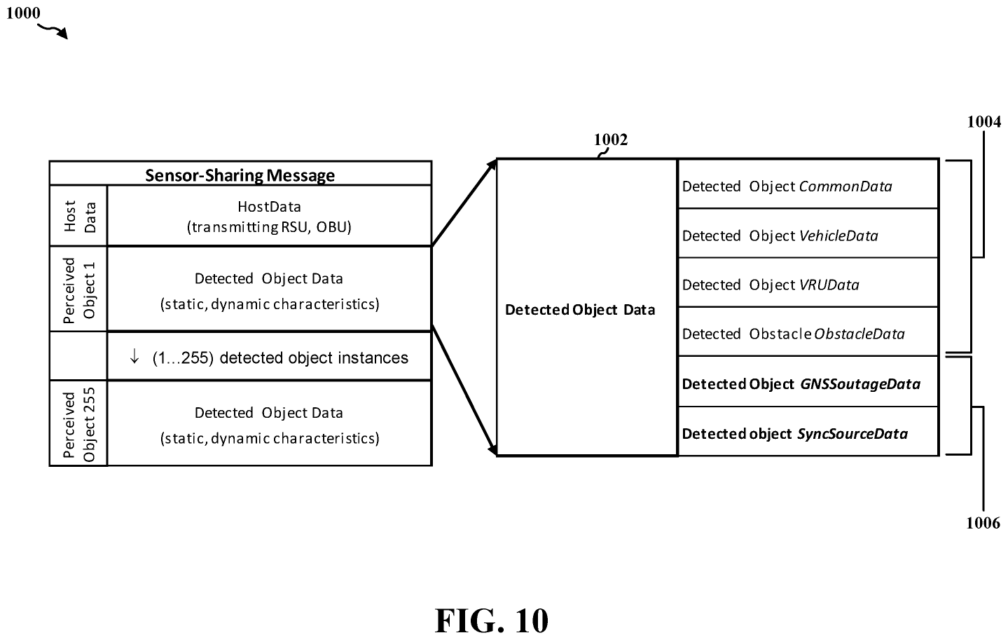

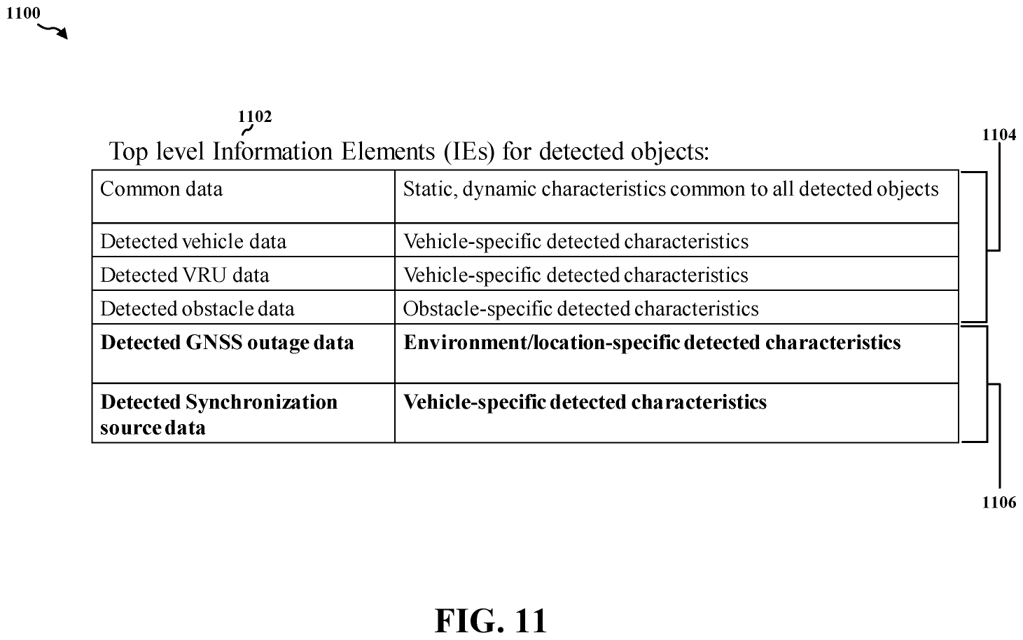

In some aspects, to report the characteristics of the threat entity 804, a hierarchical data structure may be used that comprises the report of the characteristics of the threat entity 804. In some instances, the report may include information related to the location, speed, heading, or timestamp of the VV 802. Information related to the measured RSSI of the threat entity 804 at the VV 802 may be included in the report. For example, with reference to diagram 900 of FIG. 9, the source data 902 may include information related to the VV 802, while detected object data 904 may include information related to the detected object or threat entity 804. The detected object data 904 may comprise common data related to the threat and may further comprise dedicated information 906 related to the specific threat such as a GNSS outage. The detected object data 904 may also comprise information related to detected synchronization sources. With reference to diagram 1000 of FIG. 10, the detected object data 1002 may include physical obstacles 1004 (e.g., potholes, VRU, non-V2X vehicles), and may also include detected objects 1006 related to challenging GNSS environments that obstruct synchronization with a network or detected synchronization sources that may be utilized for synchronization. For example, 1006 may include misbehaving vehicle data, jammer data, interferer data, or environmental conditions that may provide challenging GNSS environments or obstruct synchronization with a network (e.g., Detected Object GNSSoutageData), and may comprise information related to detected nearby sources of synchronization (e.g., SyncSourceData). With reference to diagram 1100 of FIG. 11, top level information elements (IE) 1102 for detected objects may include specific detected characteristics of the detected object. For example, data elements 1104 may include non-V2X vehicle data, VRU data, physical obstacle data, while data elements 1106 may include detected GNSS outage data or detected synchronization source data that may be environment/location-specific detected characteristics or vehicle-specific detected characteristics. In some aspects, for example to classify an OOB emission and/or narrowband jamming, the RSSI for each subchannel averaged over a window may be included in the report for instances where the RSSI for a particular subchannel exceeds a threshold. In some aspects, the VV 802 may report the detection of the threat entity 804 in instances where the threat entity 804 is detected over a preconfigured time interval. In some aspects, the VV 802 may combine the measured RSSI of the threat entity 804 with readings from other sensors (e.g., camera, radar, LIDAR, map data) of the VV 802 to determine a measurement of the location of the threat entity 804. In some aspects, the VV 802 may combine the measured RSSI of the threat entity 804 with V2I messages (e.g., MAP information) to determine the measurement of the location of the threat entity 804. The VV 802 may include an associated confidence value of the measurement of the location of the threat entity 804 and the measurement of the location of the threat entity 804 in the report.

In some aspects, the RV 810 may perform a mitigation action in response to receiving the SDSM or CPM. The RV 810 may perform the mitigation action in response to receiving the SDSM or CPM to avoid or mitigate contact with the threat entity 804. The threat entity 804 may obstruct wireless spectrum or resources utilized in cooperative or automated driving decisions. In some aspects, the mitigation action may comprise latching onto an existing synchronization source identified within the SDSM or CPM. For example, the SDSM or CPM may indicate that network entity 808 is a detected synchronization source, such that the RV 810 may establish a synchronization connection 814 with the network entity 808. The RV 810 may establish a synchronization connection with the network entity 808 via Uu. In some aspects, the mitigation action may comprise becoming a synchronization source. For example, the RV 810 may transmit a synchronization signal 818 (e.g., S-SSB) to become a synchronization source for other RVs (e.g., RV 816). The RV 810 becoming the synchronization source may allow RV 810 and RV 816 to enter the threat zone 806 and maintain synchronization. The RV 810 may determine to become a synchronization source in instances where existing synchronization sources (e.g., network entity 808) are not detected or indicated in the SDSM or CPM received from VV 802. In some aspects, the network entity 808 may comprise a cellular access point, such as but not limited to a base station, or a multi-access edge computing (MEC) system which may be configured to provide a detailed RF fingerprint of known threats (e.g., stationary) such as Wi-Fi Access Points at street intersections and transmit to a cloud endpoint via Uu which may be transmitted to the second wireless device. In some instances, the RSU or MEC may obtain an improved localization of the threat entity 804 than the VV 802 due, in part, to the RSU or MEC having higher computational resources and/or sensory inputs. In addition, the RSU or MEC may transmit the message reporting the threat entity 804 to the RV 816 via PC5 and/or Uu interfaces.

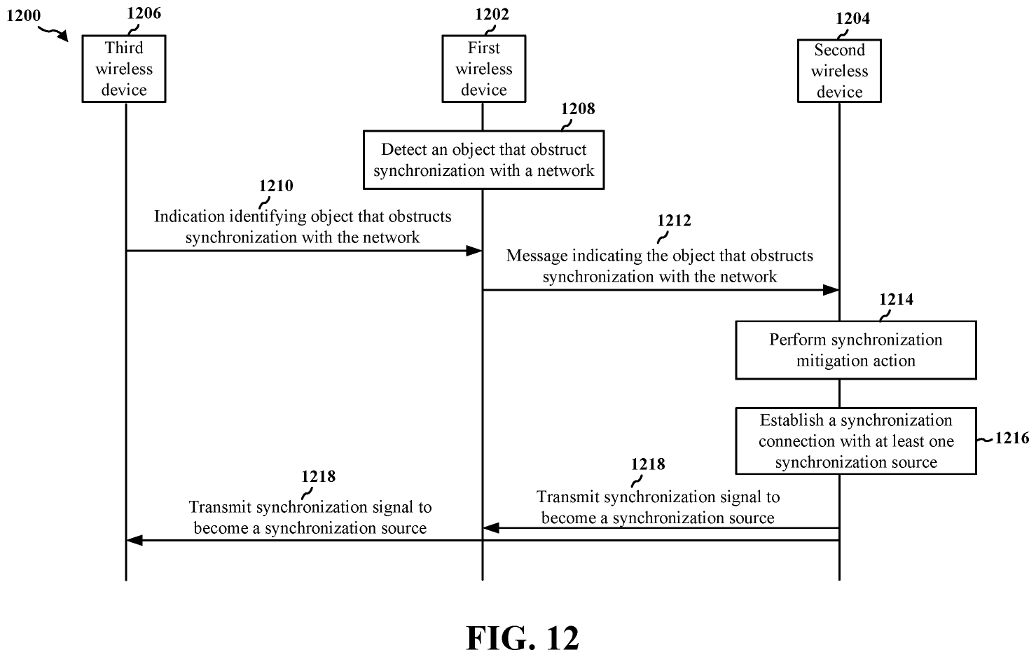

FIG. 12 is a call flow diagram 1200 of signaling between a first wireless device 1202, a second wireless device 1204, and a third wireless device 1206. The communication may be based on V2X, V2V, or D2D based communication directly from a transmitting device to a receiving device. The communication transmitting from device 1202, 1204 may be broadcast, groupcast, or unicast, and received by multiple receiving devices within range of a particular transmitting device, as described in connection with FIG. 4. The first wireless device 1202 may correspond to a first UE, and the second wireless device 1204 may correspond to a second UE. The first wireless device 1202, the second wireless device 1204, and/or the third wireless device 1206 may correspond to a C-V2X entity. For example, in the context of FIG. 1, the first wireless device 1202 may correspond to at least UE 104, and the second wireless device 1204 may correspond to at least 104′. In another example, in the context of FIG. 3, the first wireless device 1202 may correspond to the device 350, and the second wireless device 1204 may correspond to the device 310.

As illustrated at 1208, the first wireless device may detect an object in an environment that obstructs synchronization with a network. In some aspects, at least an OBU of the first wireless device may be utilized to detect the object in the environment that obstructs the synchronization with the network. The at least the OBU of the first wireless device may comprise one or more sensors that may detect the object in the environment that obstructs the synchronization with the network. The OBU of the first wireless device may also identify the object that obstructs the synchronization with the network, due in part to a combination of measured RSSI of the object with readings from one or more sensors (e.g., camera, radar, LIDAR).

As illustrated at 1210, in some instances, the third wireless device 1206 may transmit an indication that identifies the object in the environment that obstructs the synchronization with the network. The third wireless device 1206 may broadcast the indication to at least the first wireless device 1202, as well as any other wireless device within the vicinity of the third wireless device. The first wireless device 1202 may receive the indication that identifies the object in the environment that obstructs the synchronization with the network from the third wireless device 1206. The third wireless device may comprise at least one of a roadside unit (RSU), a base station, or a user equipment (UE). The indication may comprise location information related to the object that obstructs the synchronization with the network. The indication may comprise information related to one or more synchronization sources within the environment comprising obstructed synchronization with the network.

As illustrated at 1212, the first wireless device 1202 may transmit a message indicating the object that obstructs the synchronization with the network. The first wireless device 1202 may transmit the message indicating the object that obstructs the synchronization with the network to at least one second wireless device 1204. The second wireless device 1204 may receive the message indicating the object that obstructs the synchronization with the network from the first wireless device 1202. In some aspects, the message may comprise at least one IE corresponding to the object that obstructs the synchronization with the network. The at least one IE may comprise one or more detected characteristics of the object. For example, the at least one IE may comprise data corresponding to detection of GNSS outage. The GNSS outage may be based on environmental or location specific detected characteristics (e.g., tunnel, canyon, dense urban environment) which may indicate an upcoming outage (e.g., along a present or scheduled direction of travel) or may indicate a current outage, along with a location and time of when the current outage was initially detected. The at least one IE may indicate that the object that obstructs the synchronization with the network may be based at least on one of topography, geographic terrain, or one or more structures within the environment. In another example, the at least one IE may comprise data corresponding to detected synchronization sources. The at least one IE may indicate that the object that obstructs the synchronization with the network comprises a misbehaving wireless device. The data transmitted from the misbehaving wireless device may obstruct or interfere with synchronization with the network. The at least one IE may comprise location information related to the object. In some aspects, the message may comprise at least one IE corresponding to at least one synchronization source proximate the object that obstructs the synchronization with the network. The at least one synchronization source may comprise at least one of a synchronization reference user equipment (SyncRef UE), a roadside unit (RSU), or a base station. The at least one IE may comprise at least one of identifier (ID) information of the at least one synchronization source or a received reference signal received power (RSRP) of the at least one synchronization source. For example, the at least one IE may comprise data corresponding to detected synchronization sources in relation to the detection of the GNSS outage. In some aspects, the detected synchronization sources may include proximate RSUs or SyncRef UEs along with the corresponding SLSS IDs.

As illustrated at 1214, the second wireless device 1204 may perform a synchronization mitigation action. The second wireless device may perform the synchronization mitigation action in response to receiving the message indicating the object that obstructs synchronization with the network. For example, at 1216, to perform the synchronization mitigation action, the second wireless device may establish a synchronization connection with at least one synchronization source. The second wireless device may establish a synchronization connection with at least one synchronization source identified within the message before the second wireless device enters an environment having an obstructed synchronization with the network due to the object. The at least one synchronization source identified within the message may be proximate the object that obstructs the synchronization with the network. The at least one synchronization source may comprise at least one of a SyncRef UE, a RSU, or a base station. The message may comprise at least one IE corresponding to the at least one synchronization source identified within the message. The at least one IE may comprise at least one of ID of the at least one synchronization source or a received RSRP of the at least one synchronization source.

In another example, at 1218, to perform the synchronization mitigation action, the second wireless device may transmit a synchronization signal to become a synchronization source. The second wireless device, to perform the synchronization mitigation action, may transmit a synchronization signal (e.g., S-SSB) to become a synchronization source before the second wireless device enters an environment having an obstructed synchronization with the network due to the object. The second wireless device may transmit the synchronization signal to at least the first wireless device 1202 or the third wireless device 1206. The synchronization signal may be broadcast and received by additional wireless devices within the vicinity of the second wireless device 1204. In some aspects, the synchronization signal may comprise at least one of ID information of the synchronization source. In some aspects, one or more wireless devices may establish a synchronization connection with the second wireless device before the one or more wireless devices enters an environment having an obstructed synchronization with the network due to the object.

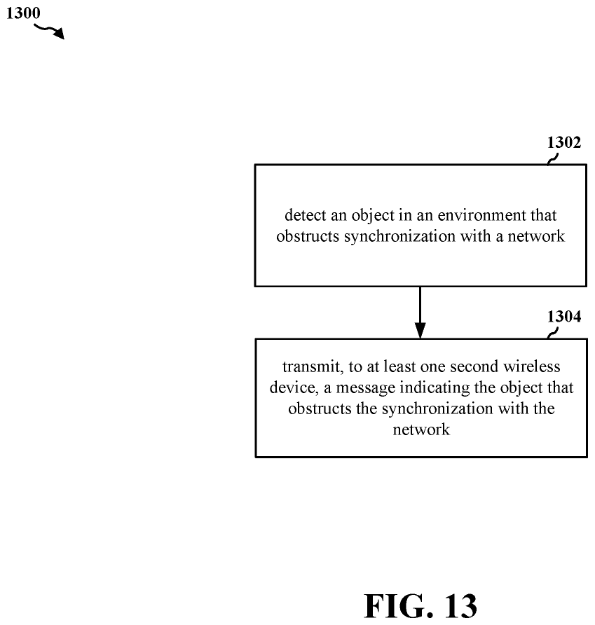

FIG. 13 is a flowchart 1300 of a method of wireless communication. The method may be performed by a first wireless device or a component of a first wireless device (e.g., the UE 104; the apparatus 1502; the cellular baseband processor 1504, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous.

At 1302, the first wireless device may detect an object in an environment that obstructs synchronization with a network. For example, 1302 may be performed by detection component 1540 of apparatus 1502. Detection component 1540 may correspond to detection component 198 of FIG. 1. In some aspects, at least an OBU of the first wireless device may be utilized to detect the object in the environment that obstructs the synchronization with the network. The at least the OBU of the first wireless device may comprise one or more sensors that may detect the object in the environment that obstructs the synchronization with the network. The OBU of the first wireless device may also detect the object that obstructs the synchronization with the network, due in part to a combination of measured RSSI of the object with readings from one or more sensors (e.g., camera, radar, LIDAR). For example, detection may be based on or related to physical characteristics of terrain of the surrounding environment, or may be signal jammers based on signal processing that determines that synchronization with the network is obstructed.

At 1304, the first wireless device may transmit a message indicating the object that obstructs the synchronization with the network. For example, 1304 may be performed by transmission component 1534. The first wireless device may transmit the message indicating the object that obstructs the synchronization with the network to at least one second wireless device. In some aspects, the message may comprise at least one IE corresponding to the object that obstructs the synchronization with the network. The at least one IE may comprise detected characteristics of the object. For example, the at least one IE may comprise data corresponding to detection of GNSS outage. The GNSS outage may be based on environmental or location specific detected characteristics (e.g., tunnel, canyon, dense urban environment) which may indicate an upcoming outage (e.g., along a present or scheduled direction of travel) or may indicate a current outage, along with a location and time of when the current outage was initially detected. The at least one IE may indicate that the object that obstructs the synchronization with the network may be based at least on one of topography, geographic terrain, or one or more structures within the environment. In another example, the at least one IE may comprise data corresponding to detected synchronization sources. The at least one IE may indicate that the object that obstructs the synchronization with the network comprises a misbehaving wireless device. The data transmitted from the misbehaving wireless device may obstruct or interfere with synchronization with the network. The at least one IE may comprise location information related to the object. In some aspects, the message may comprise at least one IE corresponding to at least one synchronization source proximate the object that obstructs the synchronization with the network. The at least one synchronization source may comprise at least one of a SyncRef UE, an RSU, or a base station. The at least one IE may comprise at least one of ID information of the at least one synchronization source or a received RSRP of the at least one synchronization source. For example, the at least one IE may comprise data corresponding to detected synchronization sources in relation to the detection of the GNSS outage. In some aspects, the detected synchronization sources may include proximate RSUs or SyncRef UEs along with the corresponding SLSS IDs.

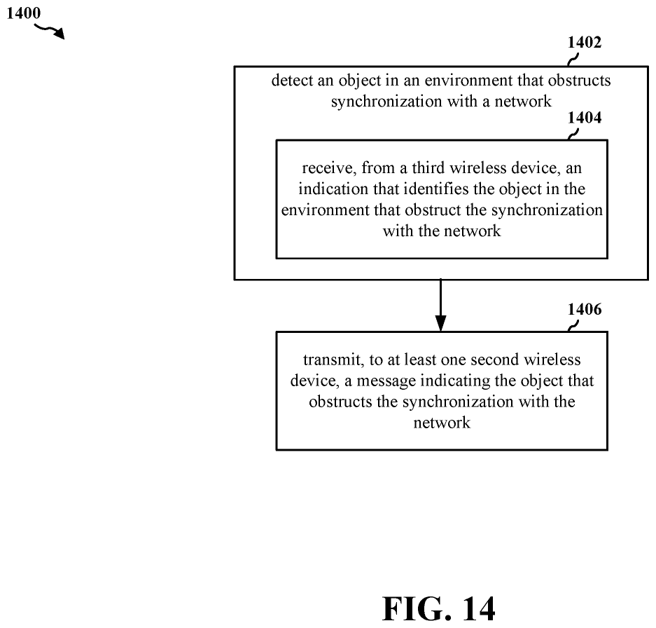

FIG. 14 is a flowchart 1400 of a method of wireless communication. The method may be performed by a first wireless device or a component of a first wireless device (e.g., the UE 104; the apparatus 1502; the cellular baseband processor 1504, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous.

At 1402, the first wireless device may detect an object in an environment that obstructs synchronization with a network. For example, 1402 may be performed by detection component 1540 of apparatus 1502. Detection component 1540 may correspond to detection component 198 of FIG. 1. In some aspects, at least an OBU of the first wireless device may be utilized to detect the object in the environment that obstructs the synchronization with the network. The at least the OBU of the first wireless device may comprise one or more sensors that may detect the object in the environment that obstructs the synchronization with the network. The OBU of the first wireless device may also detect the object that obstructs the synchronization with the network, due in part to a combination of measured RSSI of the object with readings from one or more sensors (e.g., camera, radar, LIDAR). For example, detection may be based on or related to physical characteristics of terrain of the surrounding environment, or may be signal jammers based on signal processing that determines that synchronization with the network is obstructed.

At 1404, in some aspects, to detect an object in an environment that obstructs synchronization with a network, the first wireless device may receive an indication that identifies the object in the environment that obstructs the synchronization with the network. For example, 1404 may be performed by identification component 1542 of apparatus 1502. The first wireless device may receive the indication that identifies the object in the environment that obstructs the synchronization with the network from a third wireless device. The third wireless device may comprise at least one of a roadside unit (RSU), a base station, or a user equipment (UE). The indication may comprise location information related to the object that obstructs the synchronization with the network. The indication may comprise information related to one or more synchronization sources within the environment comprising obstructed synchronization with the network.

At 1406, the first wireless device may transmit a message indicating the object that obstructs the synchronization with the network. For example, 1304 may be performed by transmission component 1534. The first wireless device may transmit the message indicating the object that obstructs the synchronization with the network to at least one second wireless device. In some aspects, the message may comprise at least one IE corresponding to the object that obstructs the synchronization with the network. The at least one IE may comprise one or more detected characteristics of the object. The at least one IE may indicate that the object that obstructs the synchronization with the network may be based at least on one of topography, geographic terrain, or one or more structures within the environment. The at least one IE may indicate that the object that obstructs the synchronization with the network comprises a misbehaving wireless device. Data transmitted from the misbehaving wireless device may obstruct or interfere with synchronization with the network. The at least one IE may comprise location information related to the object. In some aspects, the message may comprise at least one IE corresponding to at least one synchronization source proximate the object that obstructs the synchronization with the network. The at least one synchronization source may comprise at least one of a SyncRef UE, an RSU, or a base station. The at least one IE may comprise at least one of ID information of the at least one synchronization source or a received RSRP of the at least one synchronization source.

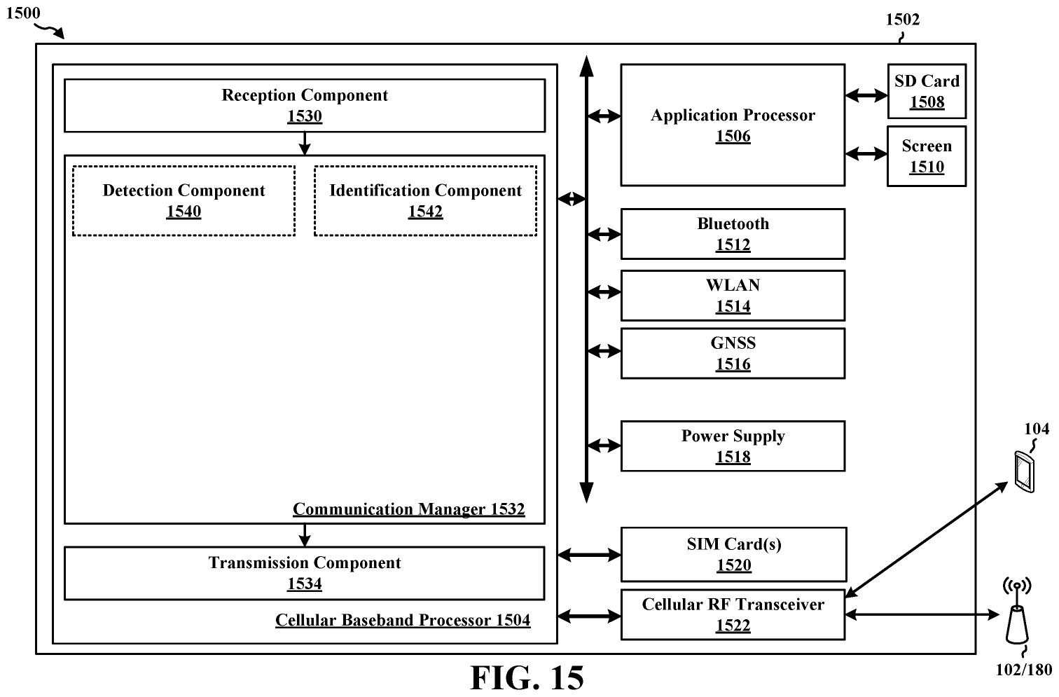

FIG. 15 is a diagram 1500 illustrating an example of a hardware implementation for an apparatus 1502. The apparatus 1502 may be a UE, a component of a UE, or may implement UE functionality. In some aspects, the apparatus1502 may include a cellular baseband processor 1504 (also referred to as a modem) coupled to a cellular RF transceiver 1522. In some aspects, the apparatus 1502 may further include one or more subscriber identity modules (SIM) cards 1520, an application processor 1506 coupled to a secure digital (SD) card 1508 and a screen 1510, a Bluetooth module 1512, a wireless local area network (WLAN) module 1514, a GNSS module 1516, or a power supply 1518. The GNSS module 1516 may comprise a variety of satellite positioning systems. For example, the GNSS module may correspond to Global Positioning System (GPS), Global Navigation Satellite System (GLONASS), Galileo, BeiDou Navigation Satellite System (BDS), Wide Area Augmentation System (WAAS), European Geostationary Navigation Overlay Service (EGNOS), GPS Aided GEO Augmented Navigation (GAGAN), Multifunctional Transport Satellites (MTSAT) Satellite Augmentation System (MSAS), Quasi-Zenith Satellite System (QZSS), or Navigation with Indian Constellation (NavIC). The cellular baseband processor 1504 communicates through the cellular RF transceiver 1522 with the UE 104 and/or BS 102/180. The cellular baseband processor 1504 may include a computer-readable medium/memory. The computer-readable medium/memory may be non-transitory. The cellular baseband processor 1504 is responsible for general processing, including the execution of software stored on the computer-readable medium/memory. The software, when executed by the cellular baseband processor 1504, causes the cellular baseband processor 1504 to perform the various functions described supra. The computer-readable medium/memory may also be used for storing data that is manipulated by the cellular baseband processor 1504 when executing software. The cellular baseband processor 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the cellular baseband processor 1504. The cellular baseband processor 1504 may be a component of the UE 350 and may include the memory 360 and/or at least one of the TX processor 368, the RX processor 356, and the controller/processor 359. In one configuration, the apparatus 1502 may be a modem chip and include just the baseband processor 1504, and in another configuration, the apparatus 1502 may be the entire UE (e.g., see 350 of FIG. 3) and include the additional modules of the apparatus 1502.

The communication manager 1532 includes an detection component 1540 that is configured to detect an object in an environment that obstructs synchronization with a network, e.g., as described in connection with 1302 of FIG. 13 or 1402 of FIG. 14. The communication manager 1532 further includes an identification component 1542 that is configured to receive an indication that identifies the object in the environment that obstructs the synchronization with the network, e.g., as described in connection with 1404 of FIG. 14. The communication manager 1532 further includes obstruction transmission component 1534 that is configured to transmit a message indicating the object that obstructs the synchronization with the network, e.g., as described in connection with 1304 of FIG. 13 or 1406 of FIG. 14.

The apparatus may include additional components that perform each of the blocks of the algorithm in the flowcharts of FIGS. 13 and 14. As such, each block in the flowcharts of FIGS. 13 and 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the cellular baseband processor 1504, includes means for detecting an object in an environment that obstructs synchronization with a network. The apparatus includes means for transmitting, to at least one second wireless device, a message indicating the object that obstructs the synchronization with the network. The apparatus further includes means for receiving, from a third wireless device, an indication that identifies the object in the environment that obstructs the synchronization with the network. The means may be one or more of the components of the apparatus 1502 configured to perform the functions recited by the means. As described supra, the apparatus 1502 may include the TX Processor 368, the RX Processor 356, and the controller/processor 359. As such, in one configuration, the means may be the TX Processor 368, the RX Processor 356, and the controller/processor 359 configured to perform the functions recited by the means.

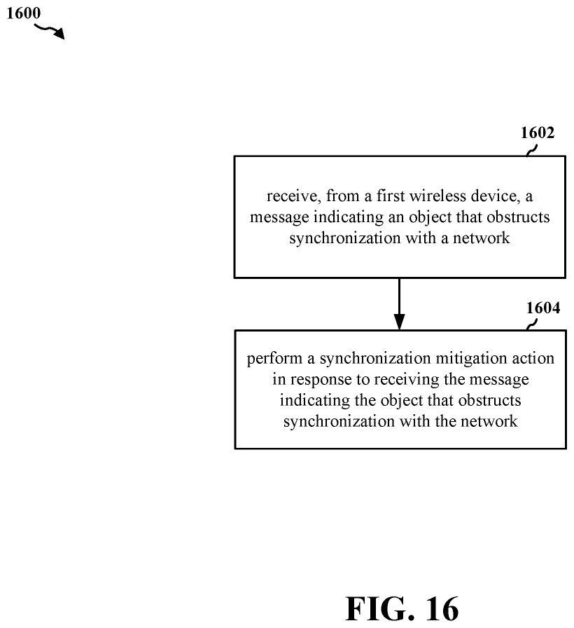

FIG. 16 is a flowchart 1600 of a method of wireless communication. The method may be performed by a second wireless device or a component of a second wireless device (e.g., the UE 104; the apparatus 1802; the cellular baseband processor 1804, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous.

At 1602, the second wireless device may receive a message indicating an object that obstructs synchronization with a network. For example, 1602 may be performed by reception component 1830 of apparatus 1802. The second wireless device may receive the message indicating the object that obstructs synchronization with the network from a first wireless device. In some aspects, the message comprises at least one IE corresponding to the object that obstructs the synchronization with the network. The at least one IE may comprise one or more detected characteristics of the object. For example, the at least one IE may comprise data corresponding to detection of GNSS outage. The GNSS outage may be based on environmental or location specific detected characteristics (e.g., tunnel, canyon, dense urban environment) which may indicate an upcoming outage (e.g., along a present or scheduled direction of travel) or may indicate a current outage, along with a location and time of when the current outage was initially detected. The at least one IE may indicate that the object that obstructs the synchronization with the network may be based at least on one of topography, geographic terrain, or one or more structures within the environment. In another example, the at least one IE may comprise data corresponding to detected synchronization sources. The at least one IE may indicate that the object that obstructs the synchronization with the network may comprise a misbehaving wireless device. The data transmitted from the misbehaving wireless device may obstruct or interfere with synchronization with the network. The at least one IE may comprise location information related to the object.

At 1604, the second wireless device may perform a synchronization mitigation action. For example, 1604 may be performed by synchronization component 1842 of apparatus 1802. Synchronization component 1842 may correspond to synchronization component 199 of FIG. 1. The second wireless device may perform the synchronization mitigation action in response to receiving the message indicating the object that obstructs synchronization with the network. For example, the second wireless device may establish a synchronization connection with at least one synchronization source prior to entering the environment having an obstructed synchronization with the network. The at least one synchronization source may comprise at least one of a SyncRef UE, a RSU, or a base station. In another example, the second wireless device may transmit a synchronization signal to become a synchronization source prior to entering the environment having an obstructed synchronization with the network.

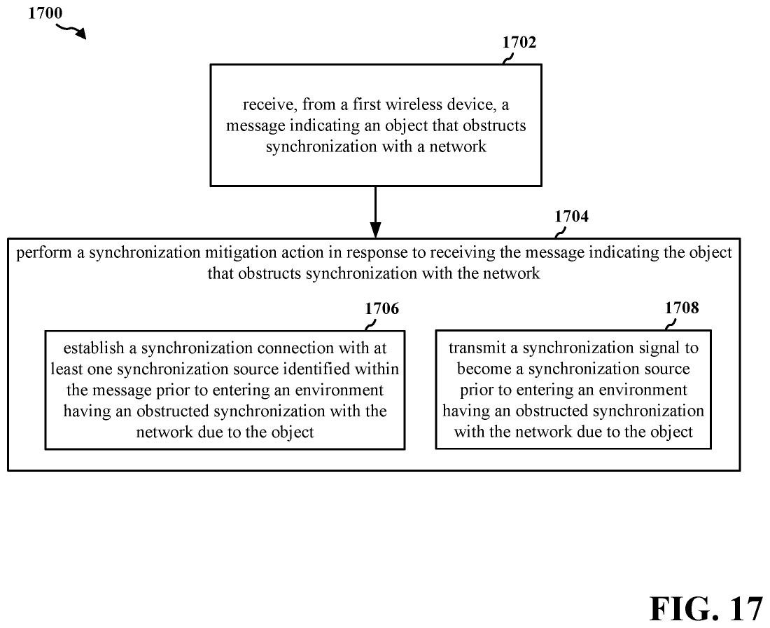

FIG. 17 is a flowchart 1700 of a method of wireless communication. The method may be performed by a second wireless device or a component of a second wireless device (e.g., the UE 104; the apparatus 1802; the cellular baseband processor 1804, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous.

At 1702, the second wireless device may receive a message indicating an object that obstructs synchronization with a network. For example, 1702 may be performed by reception component 1830 of apparatus 1802. The second wireless device may receive the message indicating the object that obstructs synchronization with the network from a first wireless device. In some aspects, the message comprises at least one IE corresponding to the object that obstructs the synchronization with the network. The at least one IE may comprise one or more detected characteristics of the object. For example, the at least one IE may comprise data corresponding to detection of GNSS outage. The GNSS outage may be based on environmental or location specific detected characteristics (e.g., tunnel, canyon, dense urban environment) which may indicate an upcoming outage (e.g., along a present or scheduled direction of travel) or may indicate a current outage, along with a location and time of when the current outage was initially detected. The at least one IE may indicate that the object that obstructs the synchronization with the network may be based at least on one of topography, geographic terrain, or one or more structures within the environment. In another example, the at least one IE may comprise data corresponding to detected synchronization sources. The at least one IE may indicate that the object that obstructs the synchronization with the network may comprise a misbehaving wireless device. The data transmitted from the misbehaving wireless device may obstruct or interfere with synchronization with the network. The at least one IE may comprise location information related to the object.

At 1704, the second wireless device may perform a synchronization mitigation action. For example, 1704 may be performed by synchronization component 1842 of apparatus 1802. Synchronization component 1842 may correspond to synchronization component 199 of FIG. 1. The second wireless device may perform the synchronization mitigation action in response to receiving the message indicating the object that obstructs synchronization with the network. For example, the second wireless device may establish a synchronization connection with at least one synchronization source before the second wireless device enters the environment having an obstructed synchronization with the network. The at least one synchronization source may comprise at least one of a SyncRef UE, a RSU, or a base station. In another example, the second wireless device may transmit a synchronization signal to become a synchronization source prior to entering the environment having an obstructed synchronization with the network.

At 1706, in some aspects, to perform the synchronization mitigation action, the second wireless device may establish a synchronization connection with at least one synchronization source. For example, 1706 may be performed by synchronization component 1842 of apparatus 1802. The second wireless device may establish a synchronization connection with at least one synchronization source identified within the message before the second wireless device enters an environment having an obstructed synchronization with the network. The at least one synchronization source may be proximate the object that obstructs the synchronization with the network. The at least one synchronization source may comprise at least one of a SyncRef UE, a RSU, or a base station. The message may comprise at least one IE corresponding to the at least one synchronization source identified within the message. The at least one IE may comprise at least one of ID of the at least one synchronization source or a received RSRP of the at least one synchronization source.

At 1708, in some aspects, to perform the synchronization mitigation action, the second wireless device may transmit a synchronization signal to become a synchronization source. For example, 1708 may be performed by synchronization component 1842 of apparatus 1802. The second wireless device, to perform the synchronization mitigation action, may transmit a synchronization signal to become a synchronization source before the second wireless device enters an environment having an obstructed synchronization with the network due to the object. In some aspects, the synchronization signal may comprise at least one of ID information of the synchronization source. In some aspects, one or more wireless devices may establish a synchronization connection with the second wireless device before the one or more wireless devices enter an environment having an obstructed synchronization with the network due to the object.

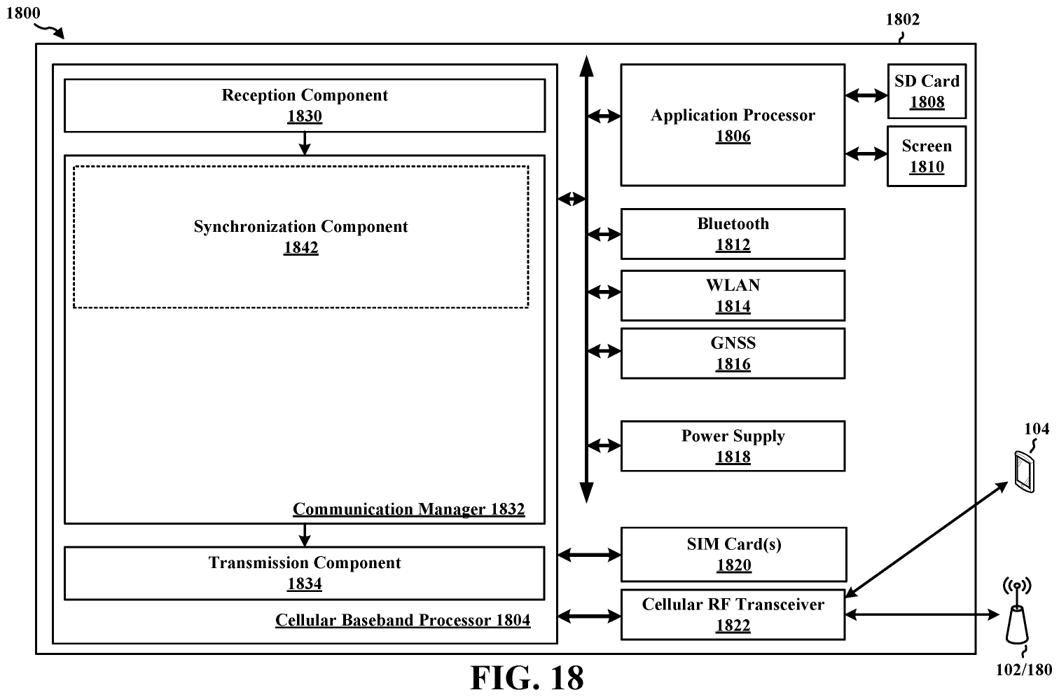

FIG. 18 is a diagram 1800 illustrating an example of a hardware implementation for an apparatus 1802. The apparatus 1802 may be a UE, a component of a UE, or may implement UE functionality. In some aspects, the apparatus1802 may include a cellular baseband processor 1804 (also referred to as a modem) coupled to a cellular RF transceiver 1822. In some aspects, the apparatus 1802 may further include one or more subscriber identity modules (SIM) cards 1820, an application processor 1806 coupled to a secure digital (SD) card 1808 and a screen 1810, a Bluetooth module 1812, a wireless local area network (WLAN) module 1814, a GNSS module 1816, or a power supply 1818. The GNSS module 1816 may comprise a variety of satellite positioning systems. For example, the GNSS module 1816 may correspond to Global Positioning System (GPS), Global Navigation Satellite System (GLONASS), Galileo, BeiDou Navigation Satellite System (BDS), Wide Area Augmentation System (WAAS), European Geostationary Navigation Overlay Service (EGNOS), GPS Aided GEO Augmented Navigation (GAGAN), Multifunctional Transport Satellites (MTSAT) Satellite Augmentation System (MSAS), Quasi-Zenith Satellite System (QZSS), or Navigation with Indian Constellation (NavIC). The cellular baseband processor 1804 communicates through the cellular RF transceiver 1822 with the UE 104 and/or BS 102/180. The cellular baseband processor 1804 may include a computer-readable medium/memory. The computer-readable medium/memory may be non-transitory. The cellular baseband processor 1804 is responsible for general processing, including the execution of software stored on the computer-readable medium/memory. The software, when executed by the cellular baseband processor 1804, causes the cellular baseband processor 1804 to perform the various functions described supra. The computer-readable medium/memory may also be used for storing data that is manipulated by the cellular baseband processor 1804 when executing software. The cellular baseband processor 1804 further includes a reception component 1830, a communication manager 1832, and a transmission component 1834. The communication manager 1832 includes the one or more illustrated components. The components within the communication manager 1832 may be stored in the computer-readable medium/memory and/or configured as hardware within the cellular baseband processor 1804. The cellular baseband processor 1804 may be a component of the UE 350 and may include the memory 360 and/or at least one of the TX processor 368, the RX processor 356, and the controller/processor 359. In one configuration, the apparatus 1802 may be a modem chip and include just the baseband processor 1804, and in another configuration, the apparatus 1802 may be the entire UE (e.g., see 350 of FIG. 3) and include the additional modules of the apparatus 1802.

The communication manager 1832 includes a reception component 1830 that is configured to receive a message indicating an object that obstructs synchronization with a network, e.g., as described in connection with 1602 of FIG. 16 of 1702 of FIG. 17. The communication manager 1832 further includes a synchronization component 1842 that is configured to perform a synchronization mitigation action, e.g., as described in connection with 1604 of FIG. 16 or 1704 of FIG. 17. The synchronization component 1842 may be further configured to establish a synchronization connection with at least one synchronization source, e.g., as described in connection with 1706 of FIG. 17. The synchronization component 1842 may be further configured to transmit a synchronization signal to become a synchronization source, e.g., as described in connection with 1708 of FIG. 17.

The apparatus may include additional components that perform each of the blocks of the algorithm in the flowcharts of FIGS. 16 and 17. As such, each block in the flowcharts of FIGS. 16 and 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1802 may include a variety of components configured for various functions. In one configuration, the apparatus 1802, and in particular the cellular baseband processor 1804, includes means for receiving, from a first wireless device, a message indicating an object that obstructs synchronization with a network. The apparatus includes means for performing a synchronization mitigation action in response to receiving the message indicating the object that obstructs synchronization with the network. The apparatus further includes means for establishing a synchronization connection with at least one synchronization source identified within the message prior to entering an environment having an obstructed synchronization with the network due to the object. The apparatus further includes means for transmitting a synchronization signal to become a synchronization source prior to entering an environment having an obstructed synchronization with the network due to the object. The means may be one or more of the components of the apparatus 1802 configured to perform the functions recited by the means. As described supra, the apparatus 1802 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a first wireless device including at least one processor coupled to a memory and at least one transceiver and configured to detect an object in an environment that obstructs synchronization with a network; and transmit, via the at least one transceiver, to at least one second wireless device, a message indicating the object that obstructs the synchronization with the network.

Aspect 2 is the apparatus of aspect 1, further includes that to detect the object in the environment, the at least one processor is further configured to receive, from a third wireless device, an indication that identifies the object in the environment that obstructs the synchronization with the network.

Aspect 3 is the apparatus of any of aspects 1 and 2, further includes that the third wireless device comprises at least one of a RSU, a base station, or a UE.

Aspect 4 is the apparatus of any of aspects 1-3, further includes that the indication comprises location information related to the object that obstructs the synchronization with the network.

Aspect 5 is the apparatus of any of aspects 1-4, further includes that the indication comprises information related to one or more synchronization sources within the environment comprising obstructed synchronization with the network.

Aspect 6 is the apparatus of any of aspects 1-5, further includes an OBU including one or more sensors, further includes that the at least one processor is configured to detect the object that obstructs the synchronization with the network using the OBU.

Aspect 7 is the apparatus of any of aspects 1-6, further includes that the message comprises at least one IE corresponding to the object that obstructs the synchronization with the network, wherein the at least one IE comprises one or more detected characteristics of the object.

Aspect 8 is the apparatus of any of aspects 1-7, further includes that the at least one IE indicates that the object that obstructs the synchronization with the network is based at least on one of topography, geographic terrain, or one or more structures within the environment.

Aspect 9 is the apparatus of any of aspects 1-8, further includes that the at least one IE indicates that the object that obstructs the synchronization with the network comprises a misbehaving wireless device, wherein data transmitted from the misbehaving wireless device obstructs or interferes with the synchronization with the network.

Aspect 10 is the apparatus of any of aspects 1-9, further includes that the at least one IE comprises location information related to the object.

Aspect 11 is the apparatus of any of aspects 1-10, further includes that the message comprises at least one IE corresponding to at least one synchronization source proximate the object that obstructs the synchronization with the network.

Aspect 12 is the apparatus of any of aspects 1-11, further includes that the at least one synchronization source comprises at least one of a SyncRef UE, a RSU, or a base station.

Aspect 13 is the apparatus of any of aspects 1-12, further includes that the at least one IE comprises at least one of ID information of the at least one synchronization source or a received RSRP of the at least one synchronization source.

Aspect 14 is a method of wireless communication for implementing any of aspects 1-13.

Aspect 15 is an apparatus for wireless communication including means for implementing any of aspects 1-13.

Aspect 16 is a computer-readable medium storing computer executable code, where the code when executed by a processor causes the processor to implement any of aspects 1-13.

Aspect 17 is an apparatus for wireless communication at a second wireless device including at least one processor coupled to a memory and at least one transceiver and configured to receive, from a first wireless device, a message indicating an object that obstructs synchronization with a network; and perform a synchronization mitigation action in response to receiving the message indicating the object that obstructs the synchronization with the network.

Aspect 18 is the apparatus of aspect 17, further includes that to perform the synchronization mitigation action, the at least one processor is further configured to establish a synchronization connection with at least one synchronization source identified within the message before the second wireless device enters an environment having an obstructed synchronization with the network due to the object.

Aspect 19 is the apparatus of any of aspects 17 and 18, further includes that the at least one synchronization source identified within the message is proximate the object that obstructs the synchronization with the network.

Aspect 20 is the apparatus of any of aspects 17-19, further includes that the at least one synchronization source comprises at least one of a SyncRef UE, a RSU, or a base station.

Aspect 21 is the apparatus of any of aspects 17-20, further includes that the message comprises at least one IE corresponding to the at least one synchronization source identified within the message.

Aspect 22 is the apparatus of any of aspects 17-21, further includes that the at least one IE comprises at least one of ID of the at least one synchronization source or a received RSRP of the at least one synchronization source.

Aspect 23 is the apparatus of any of aspects 17-22, further includes that to perform the synchronization mitigation action, the at least one processor is further configured to transmit a synchronization signal to become a synchronization source before the second wireless device enters an environment having an obstructed synchronization with the network due to the object.

Aspect 24 is the apparatus of any of aspects 17-23, further includes that the synchronization signal comprises at least one of ID information of the synchronization source.

Aspect 25 is the apparatus of any of aspects 17-24, further includes that a synchronization connection is established between the second wireless device and one or more wireless device before the one or more wireless device enters the environment having the obstructed synchronization with the network due to the object.

Aspect 26 is the apparatus of any of aspects 17-25, further includes that the message comprises at least one IE corresponding to the object that obstructs the synchronization with the network, wherein the at least one IE comprises one or more detected characteristics of the object.

Aspect 27 is the apparatus of any of aspects 17-26, further includes that the at least one IE indicates that the object that obstructs the synchronization with the network is based at least on one of topography, geographic terrain, or one or more structures.

Aspect 28 is the apparatus of any of aspects 17-27, further includes that the at least one IE indicates that the object that obstructs the synchronization with the network comprises a misbehaving wireless device, wherein the misbehaving wireless device transmits data that obstructs or interferes with the synchronization with the network.

Aspect 29 is the apparatus of any of aspects 17-28, further includes that the at least one IE comprises location information related to the object.

Aspect 30 is a method of wireless communication for implementing any of aspects 17-29.

Aspect 31 is an apparatus for wireless communication including means for implementing any of aspects 17-29.

Aspect 32 is a computer-readable medium storing computer executable code, where the code when executed by a processor causes the processor to implement any of aspects 17-29.

What is claimed is:

1. An apparatus for wireless communication at a first wireless device, comprising:
a memory;
at least one transceiver; and
at least one processor, communicatively connected to the memory and the at least one transceiver, the at least one processor configured to:
detect an object in an environment that obstructs synchronization with a network; and
transmit, via the at least one transceiver, to at least one second wireless device, a message indicating the object that obstructs the synchronization with the network.

2. The apparatus of claim 1, wherein, to detect the object in the environment, the at least one processor is further configured to:
receive, from a third wireless device, an indication that identifies the object in the environment that obstructs the synchronization with the network.

3. The apparatus of claim 2, wherein the third wireless device comprises at least one of a roadside unit (RSU), a base station, or a user equipment (UE).

4. The apparatus of claim 2, wherein the indication comprises location information related to the object that obstructs the synchronization with the network.

5. The apparatus of claim 2, wherein the indication comprises information related to one or more synchronization sources within the environment.

6. The apparatus of claim 1, further comprising:
an onboard unit (OBU) including one or more sensors;
wherein the at least one processor is configured to detect the object that obstructs the synchronization with the network using the OBU.

7. The apparatus of claim 1, wherein the message comprises at least one information element (IE) corresponding to the object that obstructs the synchronization with the network, wherein the at least one IE comprises one or more detected characteristics of the object.

8. The apparatus of claim 7, wherein the at least one IE indicates that the object that obstructs the synchronization with the network is based at least on one of topography, geographic terrain, or one or more structures within the environment.

9. The apparatus of claim 7, wherein the at least one IE indicates that the object that obstructs the synchronization with the network comprises a misbehaving wireless device, wherein data transmitted from the misbehaving wireless device obstructs or interferes with the synchronization with the network.

10. The apparatus of claim 7, wherein the at least one IE comprises location information related to the object.

11. The apparatus of claim 1, wherein the message comprises at least one information element (IE) corresponding to at least one synchronization source proximate the object that obstructs the synchronization with the network.

12. The apparatus of claim 11, wherein the at least one synchronization source comprises at least one of a synchronization reference user equipment (SyncRef UE), a roadside unit (RSU), or a base station.

13. The apparatus of claim 11, wherein the at least one IE comprises at least one of identifier (ID) information of the at least one synchronization source or a received reference signal received power (RSRP) of the at least one synchronization source.

14. A method of wireless communication at a first wireless device, comprising:
detecting an object in an environment that obstructs synchronization with a network; and
transmitting, to at least one second wireless device, a message indicating the object that obstructs the synchronization with the network.

15. The method of claim 14, wherein the detecting the object in the environment comprises:
receiving, from a third wireless device, an indication that identifies the object in the environment that obstructs the synchronization with the network.

16. The method of claim 15, wherein the third wireless device comprises at least one of a roadside unit (RSU), a base station, or a user equipment (UE).

17. The method of claim 15, wherein the indication comprises location information related to the object that obstructs the synchronization with the network.

18. The method of claim 15, wherein the indication comprises information related to one or more synchronization sources within the environment comprising obstructed synchronization with the network.

19. The method of claim 14, wherein the message comprises at least one information element (IE) corresponding to the object that obstructs the synchronization with the network, wherein the at least one IE comprises one or more detected characteristics of the object.

20. The method of claim 14, wherein the message comprises at least one information element (IE) corresponding to at least one synchronization source proximate the object that obstructs the synchronization with the network.

21. An apparatus for wireless communication at a second wireless device, comprising:
a memory;
at least one transceiver; and
at least one processor, communicatively connected to the memory and the at least one transceiver, the at least one processor configured to:
receive, from a first wireless device, a message indicating an object that obstructs synchronization with a network; and
perform a synchronization mitigation action in response to receiving the message indicating the object that obstructs the synchronization with the network.

22. The apparatus of claim 21, wherein, to perform the synchronization mitigation action, the at least one processor is further configured to:
establish a synchronization connection with at least one synchronization source identified within the message before the second wireless device enters an environment having an obstructed synchronization with the network due to the object.

23. The apparatus of claim 22, wherein the at least one synchronization source identified within the message is proximate the object that obstructs the synchronization with the network.

24. The apparatus of claim 22, wherein the at least one synchronization source comprises at least one of a synchronization reference user equipment (SyncRef UE), a roadside unit (RSU), or a base station.

25. The apparatus of claim 22, wherein the message comprises at least one information element (IE) corresponding to the at least one synchronization source identified within the message.

26. The apparatus of claim 25, wherein the at least one IE comprises at least one of identifier (ID) of the at least one synchronization source or a received reference signal received power (RSRP) of the at least one synchronization source.

27. The apparatus of claim 21, wherein, to perform the synchronization mitigation action, the at least one processor is further configured to:
transmit a synchronization signal to become a synchronization source before the second wireless device enters an environment having an obstructed synchronization with the network due to the object.

28. The apparatus of claim 27, wherein the synchronization signal comprises at least one of identifier (ID) information of the synchronization source.

29. The apparatus of claim 27, wherein a synchronization connection is established between the second wireless device and one or more wireless device before the one or more wireless device enters the environment having the obstructed synchronization with the network due to the object.

30. The apparatus of claim 21, wherein the message comprises at least one information element (IE) corresponding to the object that obstructs the synchronization with the network, wherein the at least one IE comprises one or more detected characteristics of the object.

31. The apparatus of claim 30, wherein the at least one IE indicates that the object that obstructs the synchronization with the network is based at least on one of topography, geographic terrain, or one or more structures.

32. The apparatus of claim 30, wherein the at least one IE indicates that the object that obstructs the synchronization with the network comprises a misbehaving wireless device, wherein data transmitted from the misbehaving wireless device obstructs or interferes with the synchronization with the network.

33. The apparatus of claim 30, wherein the at least one IE comprises location information related to the object.

34. A method of wireless communication at a second wireless device, comprising:
receiving, from a first wireless device, a message indicating an object that obstructs synchronization with a network; and
performing a synchronization mitigation action in response to receiving the message indicating the object that obstructs the synchronization with the network.

35. The method of claim 34, further comprising:
establishing a synchronization connection with at least one synchronization source identified within the message before the second wireless device enters an environment having an obstructed synchronization with the network due to the object.

36. The method of claim 35, wherein the at least one synchronization source comprises at least one of a synchronization reference user equipment (SyncRef UE), a roadside unit (RSU), or a base station.

37. The method of claim 35, wherein the message comprises at least one information element (IE) corresponding to the at least one synchronization source identified within the message.

38. The method of claim 34, further comprising:
transmitting a synchronization signal to become a synchronization source before the second wireless device enters an environment having an obstructed synchronization with the network due to the object.

39. The method of claim 38, wherein a synchronization connection is established between the second wireless device and one or more wireless device before the one or more wireless device enters the environment having the obstructed synchronization with the network due to the object.

40. The method of claim 34, wherein the message comprises at least one information element (IE) corresponding to the object that obstructs the synchronization with the network, wherein the at least one IE comprises one or more detected characteristics of the object.
